(19) United States
(12) Patent Application Publication
(10) Pub. No.: US 2024/0362318 A1
(43) Pub. Date: Oct. 31, 2024

(54) MEMOMETER

(71) Applicant: University of Cincinnati, Cincinnati, OH (US)

(72) Inventors: John Martin Emmert, Dayton, OH (US); Anvesh Perumalla, Dayton, OH (US)

(73) Assignee: University of Cincinnati, Cincinnati, OH (US)

(21) Appl. No.: 18/681,618

(22) PCT Filed: Aug. 8, 2022
(86) PCT No.: PCT/US2022/039693

§ 371 Date: Feb. 6, 2024

Related U.S. Application Data
(60) Provisional application No. 63/231,048, filed on Aug. 9, 2021.

(51) Int. Cl. G06F 21/44; G06F 21/73; G06F 30/34; H04L 9/32

(52) U.S. Cl. CPC G06F 21/44; G06F 21/73; G06F 30/34; H04L 9/3278

(57) ABSTRACT

An apparatus may comprise a controller programmed to establish a connection with an integrated circuit, program a plurality of cross-coupled look up tables of the integrated circuit to generate a plurality of memory cells, each pair of cross-coupled look up tables comprising one memory cell, and associate a plurality of the memory cells with a digital fingerprint of the integrated circuit, a value of each memory cell after startup of the integrated circuit comprising one bit of the digital fingerprint.

### CROSS-REFERENCE TO RELATED APPLICATION

This application claims priority to U.S. Provisional Application No. 63/231,048 filed on Aug. 9, 2021, which is incorporated herein by reference in its entirety.

### FEDERALLY SPONSORED RESEARCH STATEMENT

The present invention was made with Government support under Contract No. FA8650-14-D-1724-0003 awarded by the United States Air Force through Edaptive Computing Inc. The Government has certain rights in the invention.

### TECHNICAL FIELD

The present specification relates to protection of integrated circuits, and more particularly, to a memometer to create a physically unclonable function.

### BACKGROUND

Trustworthy integrated circuits (ICs) are essential to a variety of industries such as defense, commerce, health care, transportation, safety, and others. However, most ICs are vulnerable to malicious activities orchestrated by untrusted entities. In particular, counterfeiting or cloning of ICs has become a major concern for both military and commercial industries.

One way of detecting counterfeit or cloned ICs is through the use of physical unclonable functions (PUFs). A PUF is a physical object that, for a given input and conditions (a challenge), provides a physically defined “digital fingerprint” output (response). The fingerprint of an IC may be used to uniquely identify the IC. PUFs depend on the uniqueness of their physical microstructure, which typically depends on random physical factors introduced during manufacturing. As such, it can be difficult, if not impossible, for a malicious actor to counterfeit or clone the IC. If a cloned IC is produced, it will generally not have the same fingerprint as the genuine IC. Accordingly, an unknown IC can be interrogated with a challenge, and an incorrect response is returned, it can be determined that the IC is not genuine.

One type of PUF that may be used is a memory-based PUF for field-programmable gate arrays (FPGAs). In particular, FPGAs have traditionally been manufactured with memory cells comprising of static random access memory (SRAM) and D flip-flops (D-FFs) that were uncommitted on startup. That is, for any given FPGA, each un-programmed memory cell initializes to a random value of ‘0’ or ‘1’ upon startup of the FPGA. However, a given memory cell of a particular FPGA will typically initialize to the same value every time. The particular initialization value of any memory cell of an FPGA depends on minute variations in manufacturing of one FPGA compared to another FPGA. As such, initialization values upon startup of a set of memory cells of an FPGA may be used as a fingerprint for the FPGA.

However, some newer FPGAs are now manufactured in such a way that all built-in SRAM and D-FF memory cells initialize to the same value (either a ‘0’ or a ‘1’) on startup. As such, for these FPGAs, initialization values of SRAM and D-FF memory cells upon startup can no longer be used as a digital fingerprint. Accordingly, an improved method of generating a digital fingerprint for FPGAs is needed.

### SUMMARY

In an embodiment, an apparatus may include a controller programmed to establish a connection with an integrated circuit, program a plurality of cross-coupled look up tables comprising one memory cell; and associate a plurality of the memory cells with a digital fingerprint of the integrated circuit, a value of each memory cell after startup of the integrated circuit comprising one bit of the digital fingerprint.

In another embodiment, a method may include establishing a connection with a field programmable gate array, programming a plurality of cross-coupled look up tables of the field programmable gate array to generate a plurality of memory cells, each pair of cross-coupled look up tables comprising one memory cell; and associating a plurality of the memory cells with a digital fingerprint of the field programmable gate array, a value of each memory cell after startup of the field programmable gate array comprising one bit of the digital fingerprint.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts an example memometer, according to one or more embodiments shown and described herein;

FIG. 2 shows an IEEE 1149.1 compliant IC architecture for a TAP controller of a JTAG port taken from Kenneth Parker, 2016, ‘The Boundary-Scan Handbook (4th ed.), Springer International Publishing Switzerland, p. 11;

FIG. 3 shows a TAP controller state transition diagram;

FIG. 4 depicts a schematic diagram of the memometer of FIG. 1, according to one or more embodiments shown and described herein;

FIG. 5 depicts a schematic diagram of the memory modules of the memometer of FIGS. 1 and 4, according to one or more embodiments shown and described herein;

FIG. 6A depicts a schematic diagram of an example cross-coupled memory structure;

FIG. 6B depicts a schematic diagram of an example memory cell comprising two cross-coupled look up tables, according to one or more embodiments shown and described herein;

FIG. 7A shows an example truth table for a NAND gate;

FIG. 7B shows an example truth table for a NOR gate;

FIG. 8A shows a probability distribution of inter-chip hamming distances between fingerprints at a first location of example FPGAs;

FIG. 8B shows a probability distribution of intra-chip hamming distance at the first location of a single FPGA at different times;

FIG. 9A shows a probability distribution of inter-chip hamming distances between fingerprints at a second location of example FPGAs;

FIG. 9B shows a probability distribution of intra-chip hamming distance at the second location of a single FPGA at different times;

FIG. 10 shows artificial aging data for example FPGAs programmed by the memometer of FIGS. 1 and 4;

FIG. 11 depicts a flowchart of a method of operating the memometer of FIGS. 1 and 4 to create digital fingerprints for an FPGA, according to one or more embodiments shown and described herein; and

FIG. 12 depicts a flowchart of a method of operating the memometer of FIGS. 1 and 4 to read digital fingerprints for an FPGA, according to one or more embodiments shown and described herein.

### DETAILED DESCRIPTION

The embodiments disclosed herein are directed to a memometer device for creating and detecting digital fingerprints for an FPGA, thereby turning the FPGA into a PUF. PUFs utilize one or more unique fingerprints associated with a particular IC (e.g., an FPGA) to authenticate the IC. In particular, for a given challenge, a PUF provides a defined response that can be used as a fingerprint. The challenge response pair (CRP) should uniquely identify a device. This is typically accomplished by utilizing a challenge that triggers a response that depends on characteristics of a device that cannot be easily reproduced (e.g., minute variations in doping levels during manufacture of an IC). A weak PUF supports a relatively small number of CRPs, whereas a strong PUF scales in a manner to support a large number of CRPs.

One example of a PUF is a memory-based PUF. In this type of PUF, a CRP is based on the behavior of memory of the PUF. For example, in an FPGA, static random access memory (SRAM) and D flip-flops (DFF) may be used as memory elements. In many FPGAs, un-programmed memory cells consistently initialize to a ‘1’ or a ‘0’ value upon power up. That is, for a given FPGA, a particular set of memory cells will each initialize to a ‘1’ or ‘0’ value upon power up of the FPGA. However, for an identically manufactured FPGA, those same memory cells will have different values upon power up. That is, for any given FPGA, which memory cells power up to ‘1’ and which memory cells power up to ‘0’ is effectively random.

Accordingly, a particular set of memory cells may be used to define a fingerprint for an FPGA. For example, when an FPGA is manufactured, a certain set of memory cells (e.g., 64 memory cells) may be measured upon power up of the FPGA in order to define a digital fingerprint for the device (e.g., each memory cell startup value may represent one bit of the fingerprint). At any future point in time, if a question arises about the authenticity of the FPGA, the same memory cells may be measured on power up of the FPGA and compared to the original fingerprint. If the fingerprints match, it may be presumed that the device is authentic. However, if the device is cloned or counterfeited, the fingerprints will not match. In particular, it can be nearly impossible to copy a device such that has the same fingerprint as the original device, due to the minute changes in manufacturing that are responsible for the fingerprint of a particular device.

An apparatus that can measure a fingerprint of an FPGA is referred to herein as a memometer. In the illustrated example, a memometer connects to a Joint Test Action Group (JTAG) port of an FPGA in order to read the appropriate memory values to determine the FPGA fingerprint.

While this type of memometer works well for reading fingerprints from FPGA devices that have memory cells that initialize to a random value of ‘0’ or ‘1’ upon startup, many newer FPGA devices are manufactured in such a way that the built-in memory cells all initialize to the same value on startup. As such, in these devices, the startup value of memory cells cannot be used as a digital fingerprint. Accordingly, embodiments disclosed herein are directed to an improved memometer for determining a digital fingerprint for such FPGA devices.

In embodiments disclosed herein, rather than using a single memory cell as one bit of an FPGA fingerprint, cross-coupled look up tables (LUTs) are used to create a memory cell that has the same functionality as a cross-coupled NAND gate. A plurality of memory cells can be so created using a plurality of cross-coupled LUTs, which will have random but consistent values upon startup of the FPGA. As such, each created memory cell can be used as one bit of a digital fingerprint, as disclosed herein. An improved memometer, disclosed herein, can be used to program LUTs of an FPGA to create one or more digital fingerprints, and to read a fingerprint of an FPGA by reading memory values, as disclosed herein.

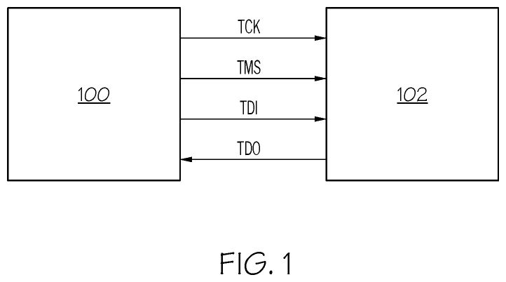

Turning now to the figures, FIG. 1 depicts a schematic diagram of a memometer 100 that may be used to program and interrogate digital fingerprints of an FPGA 102. In the illustrated example, the memometer 100 comprises an FPGA. However, in other examples, the memometer 100 may comprise any other type of hardware device capable of interfacing with the FPGA 102. In the illustrated example, the memometer 100 connects to the JTAG port of the FPGA 102. However, in other examples, the memometer 100 may connect to the FPGA 102 in other ways.

JTAG is commonly used for testing ICs. While initially used primarily for boundary-scan testing, more recently JTAG has become a standard communication protocol for programmable ICs such as FPGAs. Functions such as program, read back, verify, erase, and the like can be performed using the JTAG port.

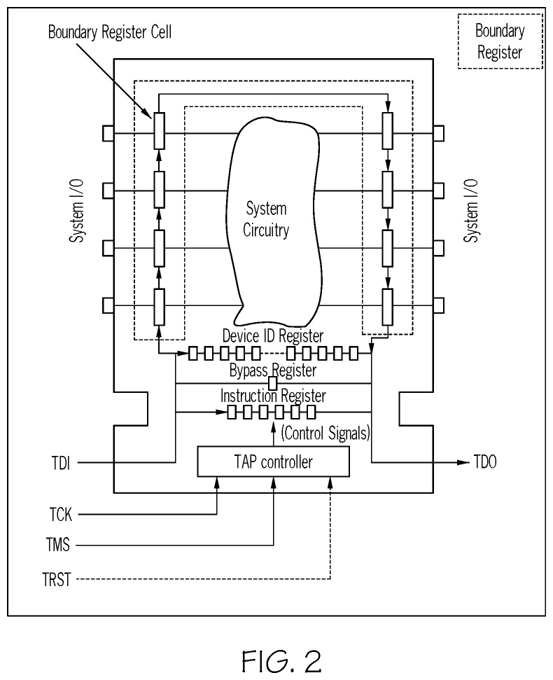

The core of the JTAG is a finite state machine (FSM), which is accessible through a test access port (TAP) controller. FIG. 2 shows an IEEE 1149.1 compliant IC architecture for the TAP controller. As shown in FIG. 2, the TAP controller has four mandatory pins: test clock input (TCK), test mode select input (TMS), test data input (TDI), and test data output (TDO). An optional test reset (TRST) can be used to reset the TAP controller. However, in the illustrated example, the memometer 100 resets the TAP controller by clocking a logic high value on a TMS for a minimum of five TCK cycles.

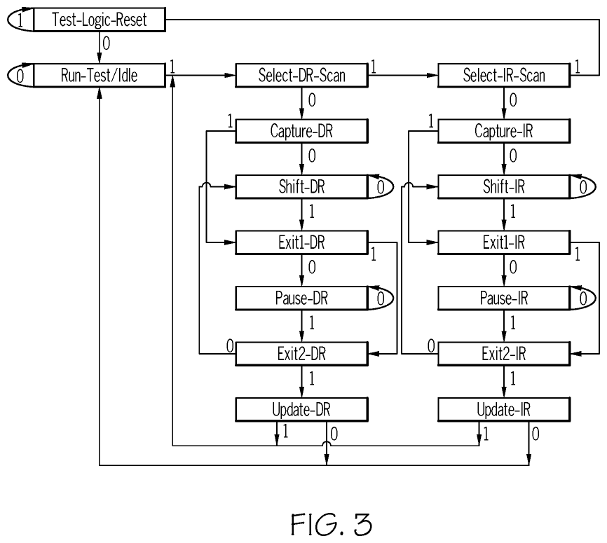

In the illustrated example, the memometer 100 is built using generic hardware descriptive language (HDL), such as VHDL or Verilog HDL. In particular, the HDL kernel of the memometer 100 sends a series of commands to the TAP FSM to access instruction registers (IR) and data registers (DR) of the FPGA 102. FIG. 3 shows a TAP controller state transition diagram. As shown in FIG. 3, the TAP controller FSM contains 16 states. These states are navigated using TMS on every positive clock cycle of TCK. The TDI input port is used to load instructions serially at every rising edge of TCK, and the TDO port is used to collect the output data at every falling edge of TCK. At power-on, the memometer 100 uses IR and DR registers to read back FPGA memory cells to create and interrogate digital fingerprints, as disclosed herein.

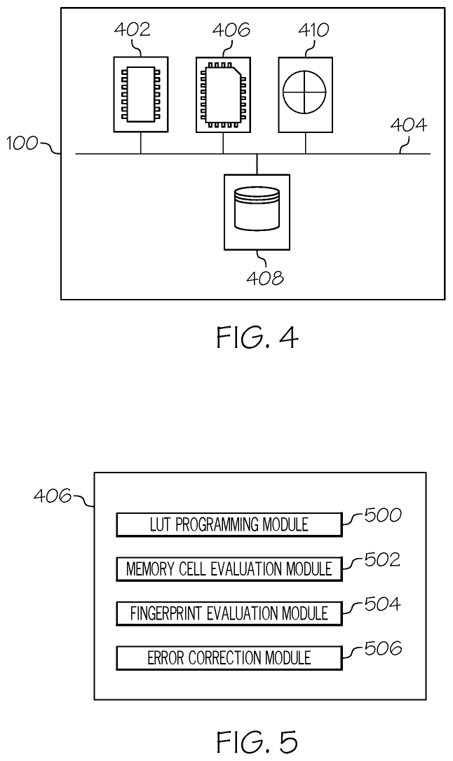

Turning now to FIG. 4, a schematic diagram of the hardware components of the memometer 100 is shown. As shown in FIG. 4, the memometer 100 includes a processor 402, a communication path 404, one or more memory modules 406, a data storage component 408, and an interface 410, the details of which will be set forth in the following paragraphs.

The processor 402 may be any device capable of executing machine readable and executable instructions. Accordingly, the processor 402 may be a controller, an integrated circuit, a microchip, a computer, or any other computing device. The processor 402 is coupled to a communication path 404 that provides signal interconnectivity between various modules of the memometer 100. Accordingly, the communication path 404 may allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 404 may be formed from any medium that is capable of transmitting a signal such as, for example, conductive wires, conductive traces, optical waveguides, or the like. In some embodiments, the communication path 404 may facilitate the transmission of wireless signals, such as Wi-Fi, Bluetooth®, Near Field Communication (NFC) and the like. Moreover, the communication path 404 may be formed from a combination of mediums capable of transmitting signals. In one embodiment, the communication path 404 comprises a combination of conductive traces, conductive wires, connectors, and buses that cooperate to permit the transmission of electrical data signals to components such as processors, memories, sensors, input devices, output devices, and communication devices. Accordingly, the communication path 404 may comprise a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The memometer 100 includes one or more memory modules 406 coupled to the communication path 404. The one or more memory modules 406 may comprise RAM, ROM, flash memories, hard drives, or any device capable of storing machine readable and executable instructions such that the machine readable and executable instructions can be accessed by the processor 402. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 406. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

The memometer 100 comprises a data storage component 408. The data storage component 408 may store data used by various components of the memometer 100. In addition, the data storage component 408 may store data received from an FPGA (e.g., the FPGA 102 of FIG. 1).

The memometer includes an interface 410 that may couple the memometer 100 to an FPGA (e.g., the FPGA 102 of FIG. 1). The interface 410 may allow data to be transferred between the memometer 100 and an FPGA. In the illustrated example, the interface 410 connects to a JTAG port of an FPGA. However, in other examples, the interface 410 may connect to FPGAs in any other manner.

Now referring to FIG. 5, the memory modules 406 of the memometer 100 are schematically shown. The memory modules 206 include an LUT programming module 500, a memory cell evaluation module 502, a fingerprint evaluation module 504, and an error correction module 506. Each of the LUT programming module 500, the memory cell evaluation module 502, the fingerprint evaluation module 504, and the error correction module 506 may be a program module in the form of operating systems, application program modules, and other program modules stored in the one or more memory modules 406. Such a program module may include, but is not limited to, routines, subroutines, programs, objects, components, data structures and the like for performing specific tasks or executing specific data types as will be described below.

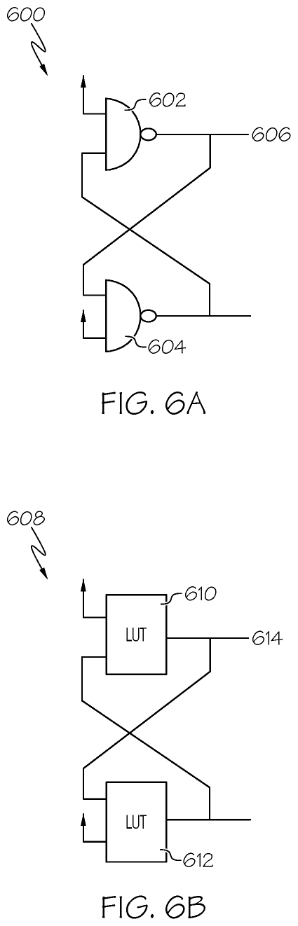

The LUT programming module 500 may program one or more LUTs of an FPGA in order to create one or more digital fingerprints for the FPGA, as disclosed herein. As discussed above, for certain FPGAs, un-programmed memory cells have a random value of either ‘1’ or ‘0’ when the FPGA is started up. For example, FIG. 6A shows a DFF that may be used as a memory cell of an FPGA. In the example of FIG. 6A, two NAND gates 602 and 604 are cross-coupled together to create a memory cell having a value corresponding to the output 606 of the NAND gate 602. Upon startup of the FPGA, the output 606 may have a random value that can be used as one bit of a digital fingerprint for the FPGA.

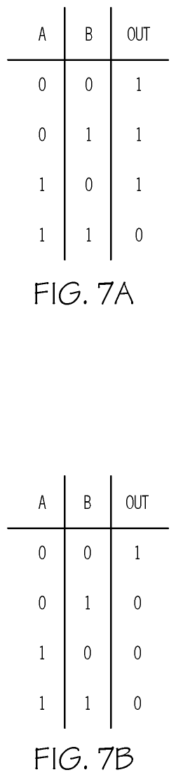

However, as discussed above, many modern FPGAs are designed such that all memory cells have the same value on startup, such that they cannot be used as a digital fingerprint. Accordingly, in the illustrated example, the LUT programming module 500 may effectively create a new memory cell by programming two cross-coupled LUTs to have the same functionality as two cross-coupled NAND gates. FIG. 6B shows a memory cell 608 comprising two cross-coupled LUTs that may be created by the LUT programming module 500. In particular, two LUTs 610 and 612 may be programmed so that the output of each LUT is input to the other LUT. The truth table for each LUT 610, 612 may be programmed to operate as a NAND gate, as shown in FIG. 7A.

By creating a new memory cell using LUTs, the outputs of the LUTs of the newly created memory cell upon FPGA startup are effectively random for any particular memory cell, but consistent upon each startup of the FPGA. As such, memory cells created by the LUT programming module 500 may be used to define a digital fingerprint for an FPGA. In the example of FIG. 6B, the output 614 of the LUT 610 may be used to define a digital fingerprint. However, in other examples, the output of the LUT 612 may be used instead.

A digital signature consisting of n bits has 2ⁿ possible values. As such, PUFs typically utilize 64-bits as a digital fingerprint, which is believed to be sufficient to uniquely identify every IC ever made. Therefore, in the illustrated example, the LUT programming module 500 programs 64 pairs of cross-coupled LUTs to create a digital fingerprint. However, in other examples, the LUT programming module 500 may program a different number of cross-coupled LUTs to create a digital fingerprint having a different number of bits.

In order to ensure that a memory cell created by the LUT programming module 500 as described above (e.g., the memory cell 608 of FIG. 6B) has a random value upon FPGA startup, the memory cell is designed to have balanced feedback delay paths between the two LUTs (e.g., the LUTs 610, 612 of FIG. 6B). If the delay paths of the two LUTs of the memory cell are not balanced, then the memory cell may have a fixed value rather than a random value upon FPGA startup.

In order to test the performance of the memometer 100 as disclosed herein, inter-chip and intra-chip hamming distances were measured on a sample device. As used herein, the inter-chip hamming distance measures the hamming distance between a digital fingerprint of two different FPGAs programmed in the same way, while the intra-chip hamming distance measures the hamming distance between the same fingerprint on one device at two different times. Ideally, the inter-chip hamming distance should be 50% since the bit values of the fingerprint are expected to be random between two different FPGAs. Furthermore, the ideal intra-chip hamming distance is 0%, since the bit values of the fingerprint are expected to be the same every time that a particular FPGA is started.

To test the memometer 100, experiments were performed on 14 Xilinx Zedboards comprising Zynq Artix-7 FPGA fabric. On each of the 14 FPGAs, the LUT programming module 500 programmed 64 memory cells, using the techniques described above, to create a 64-bit fingerprint. The same programming file (*.bit) was used to program each FPGA.

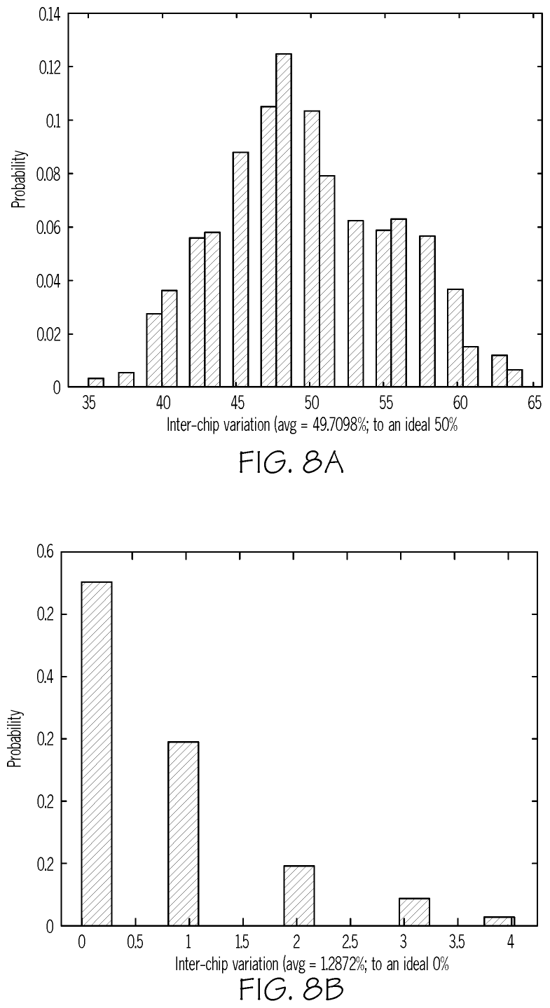

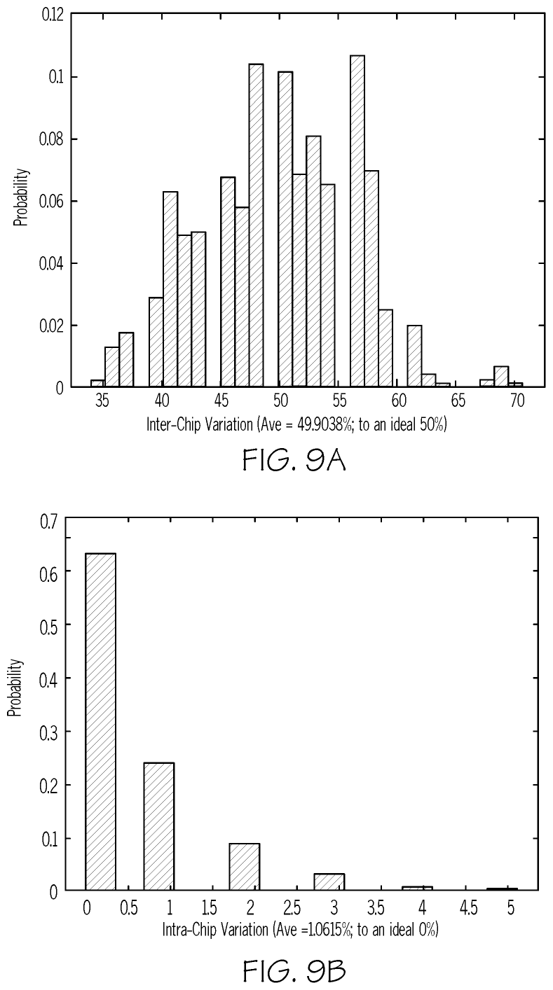

FIG. 8A shows a probability distribution of the inter-chip hamming distances between fingerprints at one location between the 14 FPGAs that were tested over 10 power cycles. The average inter-chip hamming distance from these tests is 49.7%, which is very close to the ideal 50%. FIG. 8B shows a probability distribution of the intra-chip hamming distance for a single FPGA at different times. Here the average is 1.28% which is close to the ideal 0%. Similarly, FIGS. 9A and 9B show probability distributions for inter-chip and intra-chip hamming distances that were tested at a different location on the FPGAs. At this location, the average inter-chip hamming distance is 49.9% and the average intra-chip hamming distance is 1.06%, which are also close to the ideal values of 50% and 0%. Accordingly, these tests show that the digital fingerprints generated by the memometer 100, using the techniques disclosed herein, can be used as a PUF.

Memory PUFs can be categorized as weak or strong based on the number of CRPs available. A weak PUF has a limited number of CRPs, while a strong PUF has many CRPs. A strong PUF with many CRPs ensures additional protection against cloning or counterfeiting since even if one CRP is compromised, it is unlikely that other CRPs will be comprised. Furthermore, when one CRP for a device is made public, there are other CRPs available that have not been made public.

In the illustrated example, each digital fingerprint created by the memometer 100 can be treated as a CRP. However, as disclosed herein, the memometer 100 can generate potentially thousands of fingerprints for an FPGA. As described above, the LUT programming module 500 creates a memory cell by programming two cross-coupled LUTs to function as a NAND gate, as shown in FIG. 6B. However, while the LUTs 610, 612 of FIG. 6B are shown as only having two inputs, in most FPGAs, LUTs typically have 4-6 inputs. As such, the LUT programming module 500 may create multiple fingerprints using the same pair of cross-coupled LUTs by utilizing different combinations of inputs for the LUTs. For example, if a LUT has four different inputs, the inputs to the cross-coupled LUTs in the example of FIG. 6B can be combined in 2⁴ different ways, thereby generating 16 different fingerprints from the same pair of LUTs.

Furthermore, an FPGA typically has thousands of LUTs that can be combined in different pair-wise combinations, with each pair-wise combination able to be programmed to generate 16 different fingerprints (for LUTs having 4 inputs). As such, the LUT programming module 500 can program LUTs of an FPGA to generate thousands of different fingerprints.

In addition to the thousands of digital fingerprints that can be generated as described above, in one example, the LUT programming module 500 can program a pair of cross-coupled LUTs to function as NOR gates, using the truth table shown in FIG. 7B. This can double the number of fingerprints that can be generated as compared with only programming the LUTs to function as NAND gates. Accordingly, using the techniques described herein, the memometer 100 can generate many thousands of different 64-bit digital fingerprints for a single FPGA.

Referring back to FIG. 5, the memory cell evaluation module 502 may read values of the memory cells programmed by the LUT programming module 500 to determine a particular fingerprint. As discussed above, the LUT programming module 500 can program a plurality of cross-coupled LUTs of an FPGA to create a plurality of memory cells and digital fingerprints based on the values of these memory cells upon startup of the FPGA. However, as discussed above, upon programming a particular set of LUTs to create memory cells, the values of these memory cells upon startup is effectively random and unknown. Accordingly, after one or more memory cells of an FPGA are programmed by the LUT programming module 500, as described above, the FPGA may be restarted and the memory cell evaluation module 502 may read the values of the memory cells that were programmed. The memory cell evaluation module 502 may then store the measured values in the data storage component 408 as a digital fingerprint. The memory cell evaluation module 502 may measure the values of any number of combinations of memory cells programmed by the LUT programming module 500 to record a plurality of fingerprints associated with the FPGA.

At a later time, in order to validate that an FPGA is authentic, the memometer 100 may be connected to the FPGA and the memory cell evaluation module 502 may read a set of memory cells values from the FPGA corresponding to a fingerprint stored in the data storage component 408. The fingerprint evaluation module 504 may then compare the values read by the memory cell evaluation module 502 to the corresponding fingerprint. If the values read by the memory cell evaluation module 502 match the corresponding fingerprint within a threshold of similarity, the fingerprint evaluation module 504 may determine that the FPGA is authentic. If the values read by the memory cell evaluation module 502 do not match the corresponding fingerprint within the threshold of similarity, the fingerprint evaluation module 504 may determine that the FPGA is not authentic.

In some examples, the fingerprint evaluation module 504 only determines that an FPGA is authentic only if the values read by the memory cell evaluation module 502 match an expected fingerprint exactly. However, in other examples, the fingerprint evaluation module 504 may determine that the FPGA is authentic even if some number of bits, up to a maximum allowable number, do not match the expected fingerprint. This may allow for the occasional variation in a small number of startup values of memory cells that are used to determine the digital fingerprint of the FPGA.

In order to show that digital fingerprints created by the memometer 100 are stable over time, artificial aging analysis has been performed. The most dominant aging effect in silicon aging is the negative bias temperature instability effect (NBTI). NBTI induces bias on the PMOS transistor's absolute threshold value, which can lead to bit errors in the startup values of memory cells. NBTI occurs when silicon is subjected to higher voltage and higher temperature stress. An acceleration factor (AF) is used to calculate an amount of acceleration to which the ICs are subjected. In particular, the following equation can be used:

$$AF = {( \frac{{v}_{stress}}{{v}_{nominal}} )}^{\frac{α}{n}} \times exp ( ( \frac{{E}_{α α}}{k} ) \times ( \frac{1}{{T}_{stress}} - \frac{1}{{T}_{nominal}} ) \times \frac{1}{n} )$$

where α is the gate voltage exponent, n is the time exponent, E_{αα} is the activation energy, k is the Bolztman's constant, Vₙₒₘᵢₙₐₗ is the nominal voltage, Tₙₒₘᵢₙₐₗ is the nominal temperature, Vstress is the higher stress voltage, and Tₛₜᵣₑₛₛ is the higher stress temperature.

As such, it is desirable to predict how the startup values of memory cells change overtime as an FPGA ages. Accordingly, an aging experiment was performed using five Xilinx Zedboards, which each have a Zynq 7000 processor with Artix-7 FPGA fabric. The processor's operating temperature is between 0° C. and 85° C. In order to artificially age the circuit boards, they are placed in a temperature-controlled chamber at a desired temperature and voltage.

To perform the aging test, the AF described above was used. The parameters used were a gate voltage exponent (α) of 3.5, a time exponent (n) of 0.25, an activation energy (E_{αα}) of −0.02 eV, Boltzmann's constant (k) of 8.62×10⁻⁵ eV/K, a nominal voltage (Vₙₒₘᵢₙₐₗ) of 1.8 V, a nominal temperature (Tₙₒₘᵢₙₐₗ) of 23° C., a higher stress voltage (Vₛₜᵣₑₛₛ) of 2.5 V, and a higher stress temperature (Tₛₜᵣₑₛₛ) of 80° C.

After applying these parameters to the above equation, the aging factor AF is 163.99, which means that one hour of accelerated aging provides 163.99 hours of aging, which is about one week. This AF was applied to the devices by placing them in a temperature-controlled chamber for 255 hours, which produces approximately five years of artificial aging. For a more realistic analysis, the LUTs of the FPGAs were programmed during the aging process. The circuit boards were taken out from the temperature-controlled chamber every 1, 2, 4, 8, 16, 32, 64, and 128 hours to measure the fingerprints at nominal conditions. For each aging cycle, ten startup values were acquired. The temperature-controlled chamber was set to 88° C.±11° C.

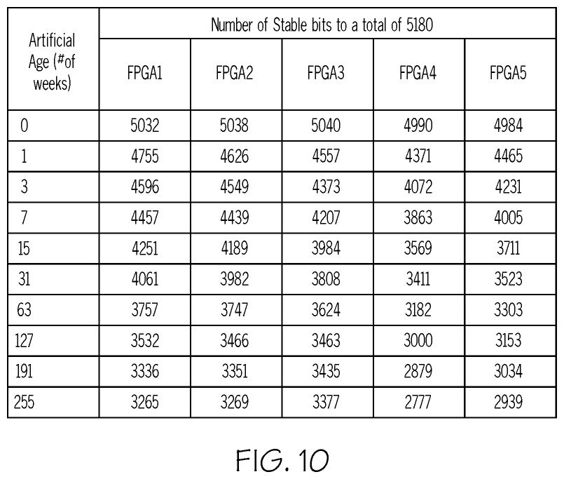

FIG. 10 shows the number of stable bits for each of the five FPGAs tested over the five year artificial aging period. The average number of stable bits for the five FPGAs tested at week 0 was 96.84%, which is 5016.31 stable bits. After five years of artificial aging, the average number of stable bits is dropped to 60.336%, which is 3125.405 stable bits. The average standard deviation of these stable values over the five years of artificial aging is 4.279%. Over the span of five years of FPGA aging, on average, if 128 startup values are taken, in the worst case, there should be at least 64 stable bits to be used as a fingerprint. As such, the artificial aging test performed show that the fingerprints created by the disclosed memometer 100 should be sufficiently stable over time to serve as a strong PUF.

Referring back to FIG. 5, the error correction module 506 may be used for error correction of a digital fingerprint, as disclosed herein. As discussed above, although fingerprints created by the memometer 100 are generally stable, over time some bits become unstable. As such, it may be desirable to add error correction. In embodiments, the error correction module 506 may add one or more bits to the end of a fingerprint created by the LUT programming module 500 for the purpose of error correction. In particular, the additional bits added by the error correction module 506 may be used to correct the fingerprint if certain bits do not match what is expected. The error correction module 506 may utilize a variety of error correction techniques. For an 8-bit fingerprint, 3 error correction bits are typically required. For a 64-bit fingerprint, about 20 error correction bits are required. However, it should be understood that any number of error correction bits may be added by the error correction module 506 depending on the particular error correction technique used.

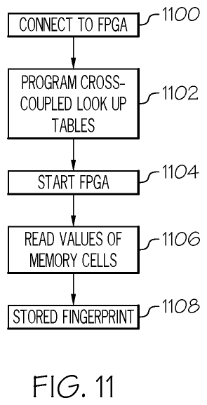

FIG. 11 depicts a flowchart of an example method that may be performed by the memometer 100 to create a digital fingerprint for an FPGA device. At step 1100, the memometer 100 is connected to an FPGA. In the illustrated example, the interface 410 of the memometer 100 is connected to a JTAG port of the FPGA. However, in other examples, the memometer 100 may be connected to the FPGA in other manners.

At step 1102, the LUT programming module 500 programs pairs of cross-coupled LUTs to create memory cells, as described above. Each memory cell, comprising of two cross-coupled LUTs, may represent one bit of a digital fingerprint. As such, the LUT programming module 500 may program multiple pairs of cross-coupled LUTs to create a complete fingerprint. In the illustrated example, the LUT programming module 500 programs 64 pairs of cross-coupled LUTs to create a 64-bit fingerprint. However, in other examples, other numbers of cross-coupled LUTs may be programmed to create fingerprints of other bit lengths.

As disclosed above, a variety of different pairs of LUTs of the FPGA may be cross-coupled to create different memory cells. In addition, different inputs of the LUTs may be used in different combination to create different memory cells. Furthermore, the two cross-coupled LUTs of a memory cell may be programmed as NAND gates or as NOR gates to create two different memory cells.

At step 1104, the FPGA is started or restarted. As disclosed herein, a memory cell created by the cross-coupled LUTs being programmed has a random value upon startup of the FPGA. Accordingly, by starting or restarting the FPGA after the LUT programming module 500 programs one or more cross-coupled LUTs to create one or more memory cells, the values of the memory cells upon startup of the FPGA may be measured to determine the bit values of a particular fingerprint.

At step 1106, the memory cell evaluation module 502 reads the values of the memory cells programmed by the LUT programming module 500 after startup of the FPGA. As discussed above, the values of the memory cells programmed by the LUT programming module 500 after startup of the FPGA comprise bit values of a digital fingerprint. Accordingly, the memory cell evaluation module 502 may read the values of the memory cells programmed by the LUT programming module 500 in order to determine the bit values of the programmed fingerprint.

At step 1108, the memory cell evaluation module 502 stores the fingerprint values read from the programmed memory cells onto the data storage component 408. In particular, the memory cell evaluation module 502 may store the bit values of a digital fingerprint and the associated memory cells from which the bit values were read in the data storage component 408. This may allow the FPGA to be later authenticated by reading back the values of the same memory cells after startup of the FPGA and comparing the values to the fingerprint stored in the data storage component 408.

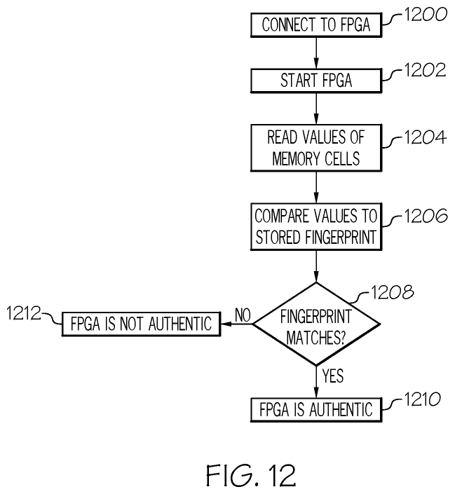

FIG. 12 depicts a flowchart of an example method for operating the memometer 100 to authenticate an FPGA. At step 1200, the memometer 100 is connected to the FPGA (e.g., by connecting the interface 410 to a JTAG port of the FPGA). At step 1202, the FPGA is started or restarted.

At step 1204, the memory cell evaluation module 502 reads the values of memory cells associated with a fingerprint after startup of the FPGA. For example, as discussed above, the data storage component 408 may store one or more fingerprint values and the memory cells associated with each of the one or more fingerprint values. Accordingly, the memory cell evaluation module 502 may read the values of the memory cells associated with a particular fingerprint to be measured.

At step 1206, the fingerprint evaluation module 504 compares the memory cell values read by the memory cell evaluation module 502 to the corresponding fingerprint stored in the data storage component 408. At step 1208, the fingerprint evaluation module 504 determines whether the values of the memory cells read by the memory cell evaluation module 502 match the associated fingerprint to within a threshold level of similarity. If the memory cell values match the associated fingerprint to within the threshold level of similarity (Yes at step 1208), then at step 1210, the fingerprint evaluation module 504 determines that the FPGA is authentic. If the memory cell values do not match the associated fingerprint to within the threshold level of similarity (No at step 1208), then at step 1212, the fingerprint evaluation module 504 determines that the FPGA is not authentic.

It should now be understood that embodiments described herein are directed to a memometer that can create digital fingerprints for an FPGA that can be used as a PUF. By cross-coupling a pair of look-up tables, the memometer can create memory cells that have random values upon startup of the FPGA, even for an FPGA with memory cells that all have the same startup value. In addition, because an FPGA typically has thousands of memory cells, the disclosed memometer can potentially thousands of different fingerprints by cross-coupling different pairs of LUTs. The memometer can also use different combinations of inputs for each pair of cross-coupled LUTs, thereby creating additional permutations of fingerprints. Lastly, the disclosed memometer can program each cross-coupled pair of LUTs as either NAND gates or NOR gates, thereby doubling the number of available fingerprints. With the ability to generate so many fingerprints for a single FPGA, the disclosed memometer can create a strong PUF.

1. An apparatus comprising a controller programmed to:
establish a connection with an integrated circuit;
program a plurality of cross-coupled look up tables of the integrated circuit to generate a plurality of memory cells, each pair of cross-coupled look up tables comprising one memory cell; and
associate a plurality of the memory cells with a digital fingerprint of the integrated circuit, a value of each memory cell after startup of the integrated circuit comprising one bit of the digital fingerprint.

2. The apparatus of claim 1, wherein the integrated circuit comprises a field programmable gate array.

3. The apparatus of claim 1, wherein the controller is further programmed to:
program each of the cross-coupled look up tables to function as a NAND gate.

4. The apparatus of claim 1, wherein the controller is further programmed to:
program each of the cross-coupled look up tables to function as a NOR gate.

5. The apparatus of claim 1, wherein each memory cell has a random value upon startup of the integrated circuit.

6. The apparatus of claim 1, wherein the cross-coupled look up tables of each memory cell have balanced feedback delay paths.

7. The apparatus of claim 1, wherein the controller is further programmed to:
create a first memory cell by cross-coupling an output of a first look up table to a first input of a second look up table and an output of the second look up table to a first input of the first look up table; and
create a second memory cell by cross-coupling the output of the first look up table to a second input of the second look up table and the output of the second look up table to a second input of the first look up table.

8. The apparatus of claim 1, wherein the controller is further programmed to:
establish the connection with the integrated circuit through a JTAG port of the integrated circuit.

9. The apparatus of claim 1, wherein the controller is further programmed to:
measure output values of the plurality of memory cells after startup of the integrated circuit; and
store the output values of the plurality of memory cells in association with the digital fingerprint.

10. The apparatus of claim 9, wherein the controller is further programmed to:
measure the output values of the plurality of memory cells of an unknown integrated circuit after startup of the unknown integrated circuit;
perform a comparison between the output values of the plurality of memory cells of the unknown integrated circuit and the digital fingerprint; and
determine whether the unknown integrated circuit is authentic based on the comparison.

11. The apparatus of claim 1, wherein the controller is further programmed to:
generate one or more error correction bits based on the digital fingerprint.

12. A method comprising:
establishing a connection with a field programmable gate array;
programming a plurality of cross-coupled look up tables of the field programmable gate array to generate a plurality of memory cells, each pair of cross-coupled look up tables comprising one memory cell; and
associating a plurality of the memory cells with a digital fingerprint of the field programmable gate array, a value of each memory cell after startup of the field programmable gate array comprising one bit of the digital fingerprint.

13. The method of claim 12, further comprising:
programming each of the cross-coupled look up tables to function as a NAND gate.

14. The method of claim 12, further comprising:
programming each of the cross-coupled look up tables to function as a NOR gate.

15. The method of claim 12, wherein each memory cell has a random value upon startup of the field programmable gate array.

16. The method of claim 12, wherein the cross-coupled look up tables of each memory cell have balanced feedback delay paths.

17. The method of claim 12, further comprising:
creating a first memory cell by cross-coupling an output of a first look up table to a first input of a second look up table and an output of the second look up table to a first input of the first look up table; and
creating a second memory cell by cross-coupling the output of the first look up table to a second input of the second look up table and the output of the second look up table to a second input of the first look up table.

18. The method of claim 12, further comprising:
establishing the connection with the field programmable gate array through a JTAG port of the field programmable gate array.

19. The method of claim 12, further comprising:
measuring output values of the plurality of memory cells after startup of the field programmable gate array; and
storing the output values of the plurality of memory cells in association with the digital fingerprint.

20. The method of claim 19, further comprising:
measuring the output values of the plurality of memory cells of an unknown integrated circuit after startup of the unknown integrated circuit;
performing a comparison between the output values of the plurality of memory cells of the unknown integrated circuit and the digital fingerprint; and
determining whether the unknown integrated circuit is authentic based on the comparison.
